(19) United States
(12) Patent Application Publication
(10) Pub. No.: US 2004/0236734 A1
(43) Pub. Date: Nov. 25, 2004

(54) Rating system and method for identifying desirable customers

(75) Inventors: Patrick Yip, Morristown, NJ (US); Praveen Reddy, Jersey City, NJ (US)

Correspondence Address: McDERMOTT, WILL & EMERY, 600 13th Street, N.W., Washington, DC, 20005-3096, US

(73) Assignee: PERSHING INVESTMENTS, LLC

(21) Appl. No.: 10/851,061

(22) Filed: May 24, 2004

Related U.S. Application Data
(60) Provisional application No. 60/472,422, filed on May 22, 2003.
(60) Provisional application No. 60/472,412, filed on May 22, 2003.
(60) Provisional application No. 60/472,748, filed on May 23, 2003.
(60) Provisional application No. 60/472,747, filed on May 23, 2003.

(51) Int. Cl. G06F 7/00

(52) U.S. Cl. 707/3

(57) ABSTRACT

An advanced rating method and system for identifying desirable customers. A prediction index is calculated for each customer to predict a trend of profit that the customer may generate. The prediction index is calculated based on various types of customer data including at least two types of customer data selected from the following: assets levels of the customer, demographic information of the customer, and transaction history of the customer. A score for each selected type of customer data is determined. Proper weights corresponding to each type of customer data are also obtained. The prediction index is then calculated based on the respective weights and scores corresponding to the selected types of customer data using an advanced algorithm. The prediction index is compared with a preset threshold to determine whether the customer is desirable.

### RELATED APPLICATIONS

This application claims the benefit of priority from the following U.S. Provisional Patent Applications: U.S. Provisional Patent Application Ser. No. 60/472,422, titled “CUSTOMER SCORING MODEL,” filed May 22, 2003, and is related to U.S. Provisional Patent Application Ser. No. 60/472,412, titled “LIFETIME REVENUE MODEL,” filed May 22, 2003; U.S. Provisional Patent Application Ser. No. 60/472,748, titled “FINANCE DATA MART ACCOUNT PROFITABILITY MODEL,” filed May 23, 2003; U.S. Provisional Patent Application Ser. No. 60/472,747, titled “FINANCIAL DATA MART ATTRITION ANALYSIS MODEL,” filed May 23, 2003; U.S. patent application Ser. No. ______ (attorney docket 67389-038), titled “CUSTOMER REVENUE PREDICTION METHOD AND SYSTEM,” filed concurrently herewith; U.S. patent application Ser. No. ______ (attorney docket 67389-039), titled “ACTIVITY-DRIVEN, CUSTOMER PROFITABILITY CALCULATION SYSTEM,” filed concurrently herewith; and U.S. patent application Ser. No. ______ (attorney docket 67389-040), titled “METHOD AND SYSTEM FOR PREDICTING ATTRITION CUSTOMERS,” filed concurrently herewith. Disclosures of the above-identified patent applications are incorporated herein by reference in their entireties.

### FIELD OF CLOSURE

This disclosure generally relates to a rating method and system to identify desirable customers, and more specifically, to a rating method and system that identify desirable customers by calculating a prediction index for each customer that predicts possible profits each customer may generate based on attributes related to the customer, such as assets levels, demographic information, and/or transaction histories.

### BACKGROUND OF THE DISCLOSURE

It is important for a company to be able to identify desirable customers from an existing customer pool. Desirability of a customer may be determined based on, for example, possible profits that the customer has generated or may bring in. A company should try its best to keep desirable customers, and dump those customers that only generate limited or minimal profits to the company. It is economically sound for a company to provide better treatment and services to desirable customers, such that the desirable customers would stay with the same company.

Nowadays, some companies use a hierarchical system to determine the types of treatments a customer may receive based on his or her desirability to a company. For example, a brokerage firm may want to provide extra care to those desirable customers, such as providing elite services, additional discounts, promotions, service inquires, etc. Even customer service centers are using automatic systems to connect incoming calls from customers based on how much profits a customer has generated or may generate. For instance, a computer system in a customer service center determines the identity of an incoming call based on the caller ID or an account number entered by the caller. The profile of the calling customer is then retrieved to determine the priority to answer the call. If the customer's profile indicates that the calling customer is a desirable customer (who may have generated or may bring in a lot of profits), the computer system ranks the incoming call as top priority, and immediately connects the call to one of the agents who specialize in handling elite clients. On the other hand, if the customer's profile indicates that the customer does not generate sufficient profits to qualify as an elite customer, the system assigns the incoming call to a general queue awaiting next available customer service agent to answer the call.

Although it is straightforward to determine the desirability of a customer based on possible profits the customer may generate, there is no effective methodology to predict what kind of customer may bring in more profits to the company. In the past, brokerage firms believed that the profits a client may generate correlated to the assets level of the client. Thus, some brokerage firms assign a customer score to each customer based on their respective assets levels: the higher a customer's assets level is, the higher the assigned customer score. If the customer score surpasses a predetermined threshold, the customer is identified as a desirable customer and would receive better treatment.

However, it has been noticed that relying solely on assets levels to identify desirable customers does not work very well. For example, in a brokerage firm, some customers may have high assets levels, but they do not participate in frequent investment activities, such as trading stocks or mutual funds, and thus only bring in limited services charges to the brokerage firm. Accordingly, such customers, although they have high assets levels, actually bring in very little income to the brokerage firm. On the other hand, some customers, although they only possess assets at insignificant levels, actually generate heavy trade activities, such as day traders. Despite their insignificant assets levels, this type of customers generates more profits for the brokerage firm and thus should be more desirable than those with high assets levels that only generate limited income to the brokerage firm. Therefore, there is a need for a more accurate system or technique to identify desirable customers.

### SUMMARY OF THE DISCLOSURE

This disclosure presents an advanced rating method and system for identifying desirable customers. One advantage of the rating method and system is that the desirability of a customer is determined based on a plurality of factors, rather than relying on assets levels alone. A prediction index is provided to indicate the desirability of each customer. Furthermore, the advanced rating method and system adopt a unique weight system to properly address different importance of various factors that may influence the accuracy of the rating.

An exemplary customer rating method calculates a prediction index for each customer based on various types of customer data including at least two types of data selected from the following: assets levels of the customer, demographic information of the customer, and transaction history of the customer. A score for each of the selected types of customer data is then determined. For example, a score for a customer's assets level may be determined by using a look-up table including relationships between assets levels and corresponding scores, to find a score corresponding to the customer's assets level. After the score for each selected type of data is determine, a prediction index for the customer is calculated based on the scores. The resulting prediction index predicts a profit trend, such as more or less profits, that the customer may generate.

In one embodiment, the prediction index for a customer is calculated by adding the score for each of the selected types of customer data. In another embodiment, a unique weight system is used to reflect different importance of various types of customer data when calculating the prediction index. For example, a predetermined weight for each type of customer data is applied to the respective score of each type of data, such as by multiplying the weight to the score, to generate a weighted score. The weighted scores for the selected types of customer data then pass through a mathematical manipulation, such as addition, to generate the prediction index. The weight for each selected type of customer data may be determined empirically, such as by regression.

In order to determine the desirability of a customer, the advanced rating method may compare the prediction index with one or more preset thresholds. Based on a result of the comparison, a desirability level may be assigned to each customer, such as Extremely Desirable, Highly Desirable, Average, Not Desirable, etc, which may be used for further processing or evaluation.

A data processing system, such as a computer, may be used to implement the rating method and system as described herein. The data processing system may include a processor for processing data and a data storage device coupled to the processor and data transmission means. The data storage device bearing instructions to cause the data processing system upon execution of the instructions by the processor to perform functions as described herein. Customer database, reference database and weight database may be implemented on the data storage device or any other data storage devices that can be accessed by the data processing system. The instructions may be embedded in a machine-readable medium to control the data processing system to perform customer rating. The machine-readable medium may include optical storage media, such as CD-ROM, DVD, etc., magnetic storage media including floppy disks or tapes, and/or solid state storage devices, such as memory card, flash ROM, etc. Such instructions may also be conveyed and transmitted using carrier waves.

Still other advantages of the presently disclosed methods and systems will become readily apparent from the following detailed description, simply by way of illustration of the invention and not limitation. As will be realized, the customer rating method and system are capable of other and different embodiments, and their several details are capable of modifications in various obvious respects, all without departing from the disclosure. Accordingly, the drawings and description are to be regarded as illustrative in nature, and not as restrictive.

### BRIEF DESCRIPTIONS OF THE DRAWINGS

The accompanying drawings, which are incorporated in and constitute a part of the specification, illustrate exemplary embodiments.

FIG. 1 is a schematic block diagram depicting architecture of an exemplary customer rating system.

FIG. 2 depicts a data structure of an exemplary customer database.

FIG. 3 shows an exemplary look-up table included in a reference database.

FIG. 4 depicts a flow chart illustrating an exemplary process for determining the desirability of a customer.

FIG. 5 shows a schematic block diagram of a data processing system upon which an exemplary customer rating system of this disclosure may be implemented.

### DETAILED DESCRIPTIONS OF ILLUSTRATIVE EMBODIMENTS

In the following description, for the purposes of explanation, numerous specific details are set forth in order to provide a thorough understanding of the present disclosure. It will be apparent, however, to one skilled in the art that the present method and system may be practiced without these specific details. In other instances, well-known structures and devices are shown in block diagram form in order to avoid unnecessarily obscuring the present disclosure.

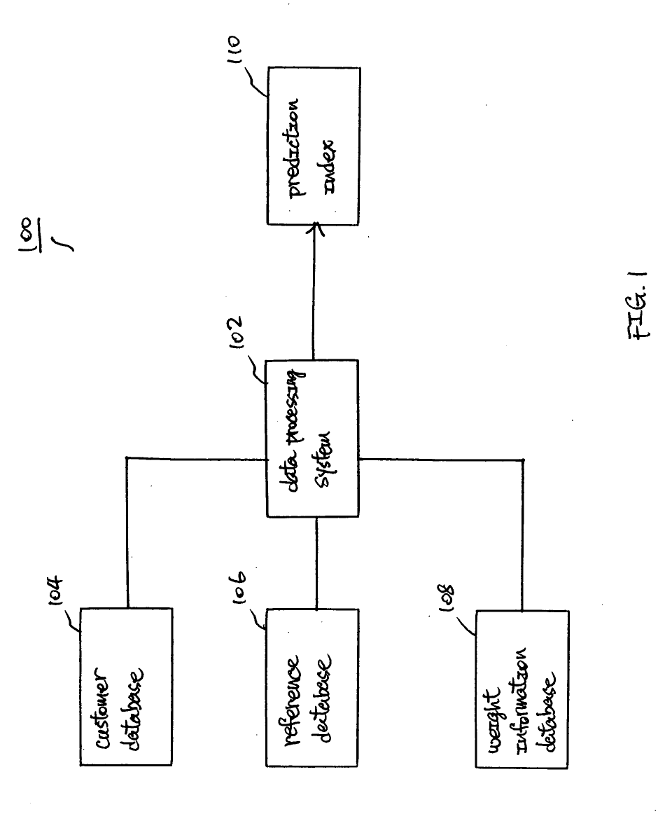

For illustration purpose, the following descriptions discuss an exemplary rating method and system for use in a brokerage firm to identify desirable customers. It is understood that the rating method and system disclosed herein may apply to many other industries, and may have different variations, which are covered by the scope of this application. In FIG. 1, a schematic block diagram of an exemplary customer rating system 100 is shown. A data processing system 102, such as a computer, is provided to generate a prediction index 110 for each of a plurality of customers based on various types of customer data. The prediction index 110 provides an indication showing or predicting how much profits a customer may generate. The data processing system 102 has access to three databases: customer database 104, reference database 106 and weight information database 108. The customer database 104 stores various types of customer data for the plurality of customers. The various types of customer data may include, but are not limited to, assets levels, demographic information, and transaction history, etc. The data processing system 102 may select part or all of the customer data stored in the customer database 104 to calculate prediction indices relating to the plurality of customers. For instance, the data processing system may select assets levels and demographic information, or assets levels and transaction history, to calculate the prediction index.

The data processing system 102 assigns a score to each selected type of customer data based on their respective contents. The reference database 106 includes reference data allowing the data processing system 102 to determine what score to assign based on the respective value or range of each type of customer data. For example, the reference database 106 may include one or more look-up tables wherein each entry of customer data may provide a corresponding assigned score. The weight information database 108 stores pre-stored weights for each type of customer data. Details of how the weights are determined will be discussed shortly. The databases as shown in FIG. 1 may be implemented in one or more data storage devices, such as hard disks or non-volatile memories, that are coupled to the data processing system 102. The data storage devices may be local to the data processing system 102 or located in another computer and coupled to the data processing system 102 via data transmission links, such as LAN (Local Area Network), internet, etc.

In calculating a prediction index for a specific customer, the data processing system 102 accesses the customer database 104 to retrieve the selected types of customer data corresponding to the specific customer. The data processing system 102 also accesses the reference database 106 to retrieve reference data related to the selected types of customer data. The data processing system 102 then assigns a score for each selected type of customer data based on the reference data. For instance, for every data entry in the selected types of customer data, the data processing system 102 determines a corresponding score to be assigned to each data entry by accessing a look-up table stored in the reference database 106. The processing system 102 then uses a unique algorithm to calculate a prediction index for the specific customer based on the assigned score for each selected type of customer data corresponding to that customer. In one embodiment, when generating the prediction index, the data processing system 102 accesses the weight information database 108 to retrieve pre-stored weights for each selected type of customer data, and applies the respective weight to the respective scores assigned to the selected types of customer data, such that different importance of each type of customer data is considered during generation of the prediction index.

In one embodiment, the data processing system 102 uses the following algorithm to determine a prediction index for a customer:

C=aA+bB+cC+dD+eE+fF+gG (a)

wherein:

C is the prediction index to be calculated;

A, B, C, D, E, F, G are the respective scores assigned to each type of customer data for the customer; and

a, b, c, d, e, f, g are the predetermined weights corresponding to each type of customer data (the process for determining the respective weight will be discussed shortly).

Although equation (a) uses six types of customer data to calculate the prediction index, the exact numbers and/or types of customer data used to generate the prediction index is not fixed to six. Rather, it depends on design preference. More or less types of customer data may be used to determine the prediction index. For instance, the customer database 102 may store customer data related to assets levels, demographic information and transaction history. However, the algorithm used by the data processing system 102 may use only two types of the customer data to generate the prediction index. For example, the algorithm may use only assets levels and demographic information to calculate the prediction index.

Details of the customer database 102, reference database 106 and weight information database 108 are now described as follows:

(1) Customer Database

The customer database 104 stores data entries related to each customer. Data entries in the customer database 104 include various types of customer data, such as assets levels, transaction histories and demographic data. A customer's assets level is defined as the sum of all assets (whenever the data is available) owned by that customer. In the brokerage example, possible assets that may be owned by a customer include, but are not limited to, common equity, preferred stock, rights/warrants, units, options, corporate debts, CMO/MBS/ABS, Money market, municipal bonds, US government/Agency bonds, mutual funds, mutual funds with load, UIT and/or any other types of instruments or assets that a customer may own.

Demographic data is defined as information in connection with attributes and/or characteristics related to a customer or may be used to identify a customer. For instance, demographic data may include, but is not limited to, duration with the brokerage firm, customers in the same household, city size, age, gender, education, marital status, income, address, status of house ownership, number and/or types of owned vehicles, household income, number of family members, number of children, ages of children, frequency of dining out, hobbies, etc. The list does not mean to be exhaustive. Any attributes related to a customer may be used to generate the prediction index after an empirical study related to their respective influence to the prediction index is conducted.

Data related to transaction history is defined as every type of information that relates to any transactions that a user has conducted in the past. Although other transaction data could be used (if known), the data typically relates to history of transactions with the firm or firms that want to calculate and use the profit prediction index, e.g. with the broker house in our example. For such an example, transaction history data may include dates of transactions, types of transactions, amount of transactions, frequency of transactions, average amount of transactions, monthly number of trades, average trades per month, total trades within a specific period of time, numbers of shares per transaction, 12-month moving average of total trades per month, etc. The transaction history data could also include actual income or profit data or metrics derived from income or profit, e.g. dollar of brokerage commissions, or actual or average percentage commissions.

Other types of customer data also may be included in the customer database 104 for use in calculation of the prediction index. For instance, for a brokerage firm, the following types of customer data may also be used: average long market value for last three months, average short market value for last three months, average total assets for last three months, average total assets for last three months, average total assets for last 12 months, commissions for last three months, interest and other fee for last three months, number of trades in last three months, fund deposit in last three months, fund withdrawal in last three months, number of account types, and/or deposit delay days, etc. The number and/or the types of customer data to be included in the customer database 104 depend on design preference. In order to determine whether one type of customer data would affect the tendency of profit generation by a customer, regression may be used to empirically determine whether a variable, or one type of data, may possibly correlate to the tendency of profit generation.

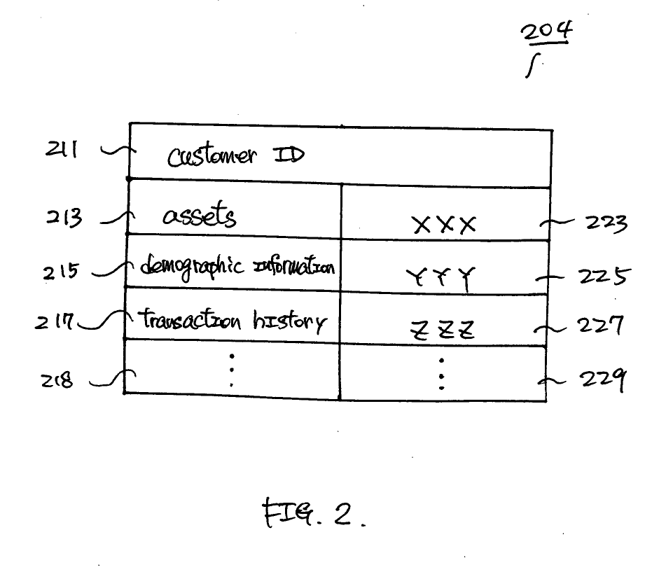

FIG. 2 shows the data structure of an exemplary data entry 204 in the customer database 104. A unique customer ID 211 is assigned to each customer for identification. The data entry 204 includes various types of customer data including assets levels 213, geographic information 215, transaction histories 217, and other types of customer data 218 that may be used to generate the prediction index 110. Information corresponding to each type of customer data is stored in data fields 223, 225, 227, 229, as described earlier.

(2) Reference Database

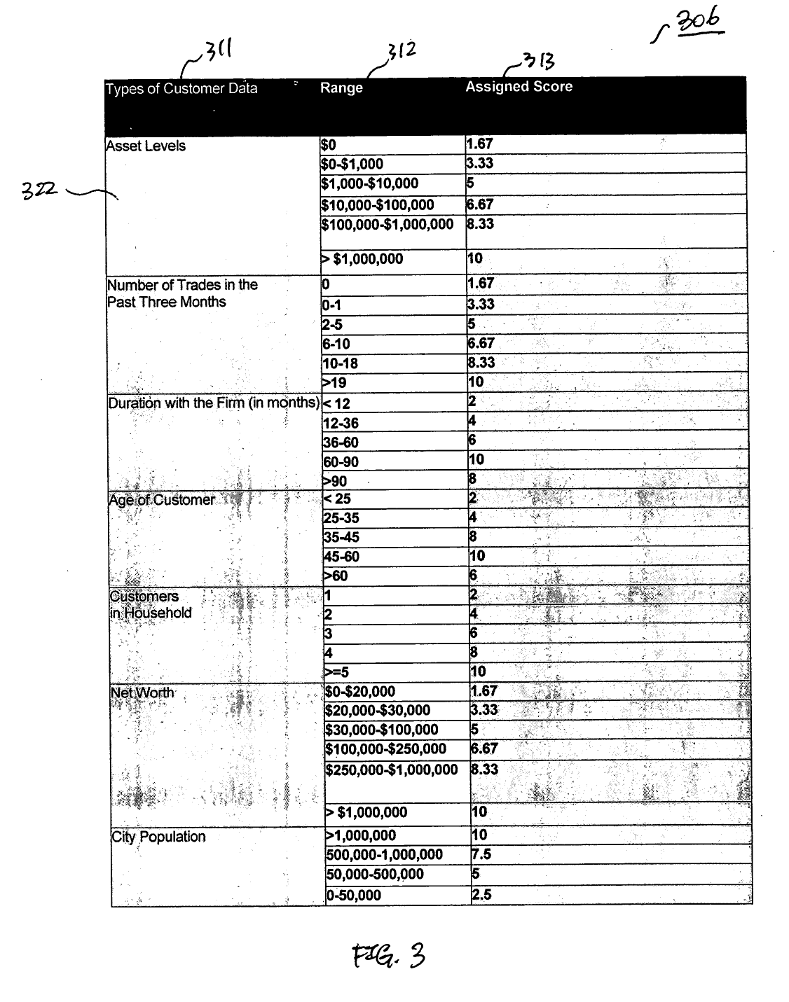

Reference database 106 stores reference data that is used by the data processing system 102 to determine a score to be assigned to each selected type of customer data corresponding to a customer. In one example, the reference data is implemented as one or more look-up tables including relationships between each type of customer data and a corresponding score to be assigned. FIG. 3 depicts a data structure of an exemplary look-up table 306 in the reference database 106. Data field 311 identifies the types of customer data, and data field 312 lists contents or ranges corresponding to each type of customer data. Data field 313 shows assigned scores corresponding to the range or content of the customer data identified in data field 312. For instance, in data field 322, the identified type of customer data is “assets levels.” The assets levels are further divided into 6 ranges: $0, $0 to $1,000, $1,000 to $10,000, $10,000 to $100,000, $100,000 to $1,000,000, and >$1,000,000. A score is assigned to each range of assets levels. As shown in FIG. 3, score 1.67 is assigned to customers with assets level at $0 dollar, score 3.33 is assigned to customers with assets level between $0 and 1,000 dollars, and score 5 is assigned to customers with assets level between $1,000 and $10,000.

In order to determine a score based on a customer's assets level, the data processing system 102 first accesses the customer database 102 to retrieve data related to the client's assets and calculates the total amount of the client's assets. The data processing system 102 then determines the score to be assigned to the customer by finding a corresponding range in “Assets Levels” 322 of the look-up table 306. For instance, if it is determined that the total amount of a customer's assets is $375,000, the customer's assets fall between $100,000 and $1,000,000. As shown in FIG. 3, the corresponding score for that range is 8.33. Thus, score 8.33 is assigned to that customer based on his/her assets level. Look-up table 306 also includes information for other types of customer data and corresponding scores, such as trading activity, duration with the firm, age of customer, number of customers in household, net worth of the customer, and population of the city where the customer lives.

The score distributions and score assignments in connection with a specific type of data do not have to be consistent across all the types of customer data. The assigned scores within a specific type of data may depend on how significant a variable or a type of customer data may be to predicting the profit that a customer may generate. Higher scores may be assigned to more significant customer data, while lower scores may be assigned to less important customer data. Furthermore, the score distribution relative to a specific type of customer data may be of various different types, such as linear distribution, normal distribution, etc.

(3) Weight Information Database

As discussed earlier, after the data processing system 102 determines a score for each type of customer data corresponding to a specific customer, the data processing system 102 may use equation (a) to calculate a prediction index for the specific customer. Equation (a) is reproduced below:

C=aA+bB+cC+dD+eE+fF+gG (a)

wherein:

C is the prediction index to be calculated;

A, B, C, D, E, F, G are the respective scores assigned to each type of customer data for the customer; and

a, b, c, d, e, f, g are the respective weights corresponding to each type of customer data.

Weight information database 108 stores predetermined weight information corresponding to each type of customer data used in generating the prediction index.

According to one embodiment, the respective value of weight corresponding to each type of customer data is determined using regression. For instance, in order to obtain the values of the weights a-g in equation (a), the following regression equation is used:

R=aA+bB+cC+dD+eE+jF+gG (b)

wherein:

R=known profits generated by each customer or a prediction index pre-assigned to each customer based on the profits they have generated or may generate according to real data or empirical study;

A-G are the respective scores corresponding to real customer data of different types that are input to equation (a); and

a-g represent the corresponding weights for each selected type of data.

During the regression process, customer data retrieved from a known customer pool is fed to regression equation (b), in order to ascertain the respective coefficient (weight) a-g corresponding to each type of customer data, which corresponds to a tendency of influence to profits or prediction index from each type of customer data. After the regression process, the value of weights a-g corresponding to each type of customer data are determined and stored in a data storage device, such as a hard disk, accessible by the data processing system 102 when calculating a prediction index using equation (a).

According to one embodiment, the respective weight for each type of customer data can be incorporated into the reference data. For instance, in a look-up table stored in the reference database, the scores to be assigned to each type of customer data already reflect the corresponding weight for each type of data. One type of customer data that plays a more important role in predicting profits generated by a customer is given or assigned a higher score than that of another type of customer data with less influence, such that the customer rating system could eliminate the step of applying weights to each calculated customer score when calculating the prediction index.

After the prediction index for a customer is determined, the data processing system 102 may apply one or more preset thresholds to the determined prediction index to ascertain whether the customer is desirable to the brokerage firm. For example, the preset thresholds may be as follows:

| Customer Score | Desirability |
|---|---|
| 80< | Extremely Desirable |
| 60-80 | Highly Desirable |
| 40-60 | Desirable |
| 20-40 | Average |
| 0-20 | Not Desirable |

After the data processing system 102 has ascertained the desirability for each customer the brokerage firm has, the data processing system 102 may generate a report showing the desirability of each customer. This report may be implemented as a computer file for further access by the data processing system 102 or other data processing systems, in order to provide different levels of services to customers based on their respective prediction indices. For instance, the report may be accessed by a computer in a calling center to discriminate between incoming calls to determine which calls should be answered at a higher priority based on which customer makes the call and how desirable the customer is to the brokerage firm. A phone call made by a first customer with higher prediction index should be given a higher priority than a phone call made by a second customer with lower prediction index, even though the second customer may have called first.

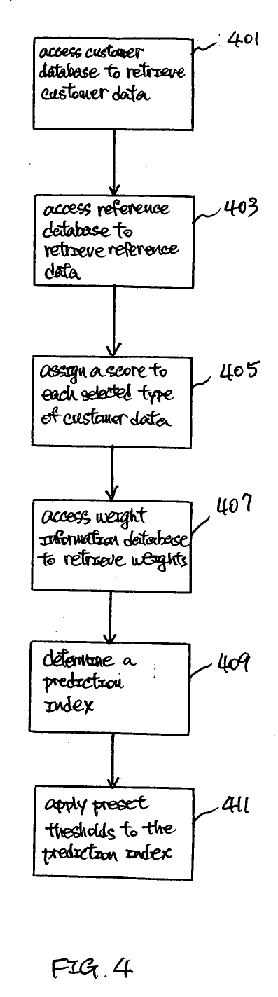

FIG. 4 depicts a flow chart illustrating a process for determining the desirability of a customer. In Step 401, the data processing system 102 accesses the customer database 104 to retrieve various types of customer data for the customer. In Step 403, the data processing system 102 accesses reference database 106 for reference data. The data processing system 102 then assigns a score to each type of customer data corresponding to the customer based on the reference data and the customer data (Step 405). In Step 407, the data processing system 102 accesses weight information database 108 to obtain weight information for each type of customer data. In Step 409, the data processing system 102 calculates a prediction index for the customer by applying the respective weights and assigned scores for the customer data to equation (a) as discussed previously. The data processing system 102 then applies preset thresholds to the calculated prediction index to determine the desirability of the customer (Step 411). Although Steps 401, 403 and 405 are shown in FIG. 4 as being performed in a sequence, the steps may be performed concurrently. Alternatively, the data processing system 102 may perform Steps 403 and 405 first and store the weight information and the reference data in the memory of the data processing system 102, for later access, such that the Steps 403 and 405 do not have to be repeated for each customer.

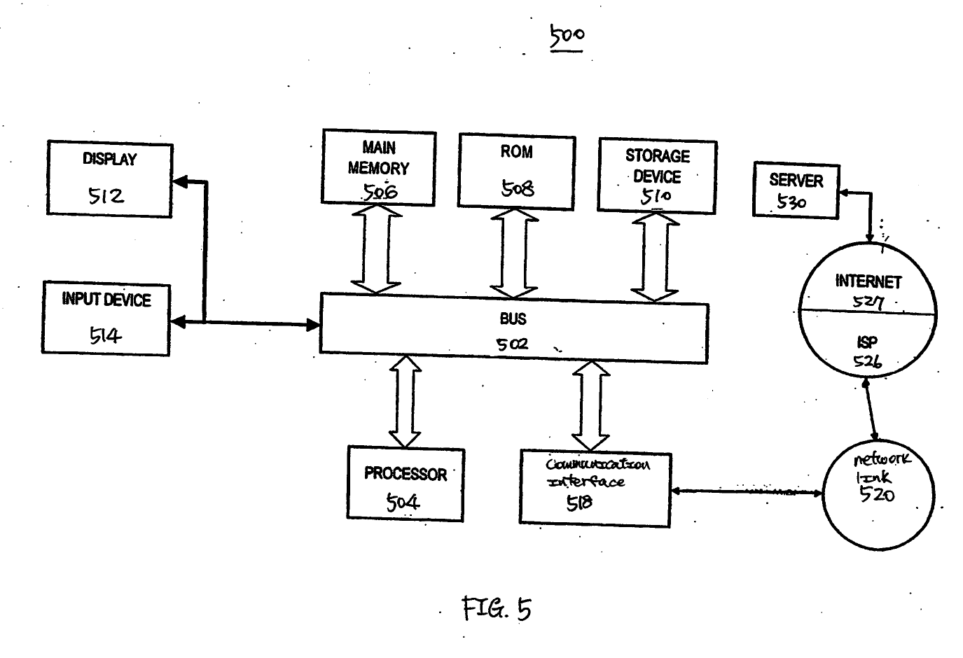

FIG. 5 shows a block diagram of an exemplary data processing system 500 upon which the customer rating system 100 and/or the data processing system 102 may be implemented. The data processing system 500 includes a bus 502 or other communication mechanism for communicating information, and a data processor 504 coupled with bus 502 for processing data. The data processing system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by data processor 504. Data processing system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions. The data processing system 500 may also have suitable software and/or hardware for converting data from one format to another. An example of this conversion operation is converting format of data available on the system 500 to another format, such as a format for facilitating transmission of the data.

The data processing system 500 may be coupled via bus 502 to a display 512, such as a cathode ray tube (CRT), plasma display panel or liquid crystal display (LCD), for displaying information to an operator. An input device 514, including alphanumeric and other keys, is coupled to bus 502 for communicating information and command selections to processor 504. Another type of user input device is cursor control (not shown), such as a mouse, a touch pad, a trackball, or cursor direction keys and the like for communicating direction information and command selections to processor 504 and for controlling cursor movement on display 512.

The data processing system 500 is controlled in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. For instance, under the control of pre-stored instructions, the data processor 504 accesses customer data, reference data and/or weight data stored in the data storage device 510 and/or other data storage device coupled to the data processing system, and generates customer scores and/or prediction indices for customers. In alternative embodiments, hard-wired circuitry may be used in place of or in combination with software instructions to implement the disclosed customer rating. Thus, customer rating embodiments are not limited to any specific combination of hardware circuitry and software.

The term “machine readable medium” as used herein refers to any medium that participates in providing instructions to processor 504 for execution or providing data to the processor 504 for processing. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502 or an external network. Transmission media can also take the form of acoustic or light waves, such as those generated during radio wave and infrared data communications, which may be carried on the links of the bus or external network.

Common forms of machine readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a data processing system can read.

Various forms of machine-readable media may be involved in carrying one or more sequences of one or more instructions to processor 504 for execution. For example, the instructions may initially be carried on a magnetic disk of a remote data processing system, such as a server. The remote data processing system can load the instructions into its dynamic memory and send the instructions over a telephone line using a modem. A modem local to data processing system 500 can receive the data on the telephone line and use an infrared transmitter to convert the data to an infrared signal. An infrared detector can receive the data carried in the infrared signal, and appropriate circuitry can place the data on bus 502. Of course, a variety of broadband communication techniques/equipment may be used for any of those links. Bus 502 carries the data to main memory 506, from which processor 504 retrieves and executes instructions and/or processes data. The instructions and/or data received by main memory 506 may optionally be stored on storage device 510 either before or after execution or other handling by the processor 504.

Data processing system 500 also includes a communication interface 518 coupled to bus 502. Communication interface 518 provides a two-way data communication coupling to a network link 520 that is connected to a local network. For example, communication interface 518 may be an integrated services digital network (ISDN) card or a modem to provide a data communication connection to a corresponding type of telephone line. As another example, communication interface 518 may be a wired or wireless local area network (LAN) card to provide a data communication connection to a compatible LAN. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network to data equipment operated by an Internet Service Provider (ISP) 526. ISP 526 in turn provides data communication services through the world wide packet data communication network now commonly referred to as the Internet 527. Local ISP network 526 and Internet 527 both use electrical, electromagnetic or optical signals that carry digital data streams. The signals through the various networks and the signals on network link 520 and through communication interface 518, which carry the digital data to and from data processing system 500, are exemplary forms of carrier waves transporting the information.

The data processing system 500 can send messages and receive data, including program code, through the network(s), network link 520 and communication interface 518. In the Internet example, a server 530 might transmit a requested code for an application program through Internet 527, ISP 526, local network and communication interface 518. The program, for example, might implement customer rating, as outlined above. The communications capabilities also allow loading of relevant data into the system, for processing in accord with the customer rating application.

The data processing system 500 also has various signal input/output ports for connecting to and communicating with peripheral devices, such as printers, displays, etc. The input/output ports may include USB port, PS/2 port, serial port, parallel port, IEEE-1394 port, infra red communication port, etc., and/or other proprietary ports. The data processing system 500 may communicate with other data processing systems via such signal input/output ports.

Although currently the most common type, those skilled in the art will recognize that personal computers (PCs) are only one type of data processing systems that may be used to implement the rating system. Other end-user devices include portable digital assistants (PDAs) with appropriate communication interfaces, cellular or other wireless telephone devices with web or Internet access capabilities, web-TV devices, etc.

The rating system and method as discussed herein may be implemented using a single data processing system, such as a single PC, or a combination of a plurality of data processing systems of different types. For instance, a client-server structure or distributed data processing architecture can be used to implement the rating system, in which a plurality of data processing systems are coupled to a network for communicating with each other. Some of the data processing systems may serve as servers handling data flow, providing calculation services or access to customer data, and/or updating software residing on other data processing systems coupled to the network.

It is intended that all matter contained in the above description and shown in the accompanying drawings shall be interpreted as illustrative and not in a limiting sense. It is also to be understood that the following claims are intended to cover all generic and specific features herein described and all statements of the scope of the various inventive concepts which, as a matter of language, might be said to fall therebetween.

What is claimed is:

1. A customer rating method comprising the steps of:
accessing data related to a customer, the accessed data including at least two types of data selected from the group consisting of: assets levels of the customer, demographic information of the customer, and transaction history of the customer;
determining a score for each of the selected types of data related to the customer; and
calculating a prediction index for the customer based on the score for each of the selected types of data related to the customer;
wherein the prediction index predicts a profit trend that the customer may generate.

2. The method of claim 1, wherein the step of calculating the prediction index for the customer is comprises adding the score for each of the selected types of data related to the customer.

3. The method of claim 1, wherein the calculating step comprises the steps of:
accessing a weight for each of the selected types of data related to the customer; and
calculating the prediction index for the customer based on the score for each of the selected types of data related to the customer and the weight for each of the selected types of data related to the customer.

4. The method of claim 3, wherein the weight for each of the selected types of data related to the customer is determined by regression.

5. The method of claim 1 further comprising the steps of:
accessing data related to a profit threshold;
comparing the prediction index with the data related to the profit threshold; and
indicating whether the customer is desirable based on a result of the comparing step.

6. The method of claim 1, wherein the profit trend indicates a tendency of a client in generating profits.

7. The method of claim 6, wherein the profits are associated with trading or brokerage profits.

8. The method of claim 1 further comprising a step of determining a level of service to the customer based on the calculated prediction index.

9. The method of claim 8, wherein the service level relates to the priority of answering a phone call made by the customer.

10. The method of claim 1, wherein the step of determining the score for each of the selected types of data related to the customer comprising the steps of:
accessing reference data including scores to be assigned to each of the selected types of data;
comparing each of the selected types of data with corresponding reference data; and
determining the score for each of the selected types of data based on a result of the comparing step.

11. The method of claim 10, wherein the reference data comprises a look-up table including relationships between each of the selected types of data and a corresponding score.

12. A data processing system for rating customers comprising:
a processor for processing data;
a data storage device coupled to the processor;
the data storage device bearing instructions to cause the data processing system to perform the steps of:
accessing data related to a customer, the accessed data including at least two types of data selected from the group consisting of: assets levels of the customer, demographic information of the customer, and transaction history of the customer;
determining a score for each of the selected types of data related to the customer; and
calculating a prediction index for the customer based on the score for each of the selected types of data related to the customer;
wherein the prediction index predicts a profit trend that the customer may generate.

13. The system of claim 12, wherein the data processing system is controlled to calculate the prediction index for the customer by adding the score for each of the selected types of data related to the customer.

14. The system of claim 12, wherein the data storage device further bears instructions to cause the data processing system to perform the steps of:
accessing a weight for each of the selected types of data related to the customer; and
calculating the prediction index for the customer based on the score for each of the selected types of data related to the customer and the weight for each of the selected types of data related to the customer.

15. The system of claim 14, wherein the data processing system is controlled to calculate the weight for each of the selected types of data related to the customer by regression.

16. The system of claim 12, wherein the data processing system is controlled to determine the score for each of the selected types of data related to the customer by performing the steps of:
accessing reference data including scores to be assigned to each of the selected types of data;
comparing each of the selected types of data with corresponding reference data; and
determining the score for each of the selected types of data based on a result of the comparing step.

17. The system of claim 12, wherein the data storage device further bears instructions to cause the data processing system to perform the steps of:
accessing data related to a profit threshold;
comparing the prediction index with the data related to the profit threshold;
indicating whether the customer is desirable based on a result of the comparing step.

18. The system of claim 12, wherein the profit trend represents a tendency of a client in generating profits.

19. The system of claim 18, wherein the profits are associated with trading or brokerage profits.

20. The system of claim 12, wherein the data storage device further comprises instructions to cause the data processing system to determine a level of service to the customer based on the calculated prediction index.

21. The system of claim 20, wherein the service level relates to the priority of answering a phone call made by the customer.

22. A program comprising instructions, which may be embodied in a machine-readable medium, for controlling a data processing system to rate customers, the instructions upon execution by the data processing system causing the data processing system to perform the steps as in the method of claim 1.

23. The program of claim 22, wherein the step of calculating the prediction index comprises adding the score for each of the selected types of data related to the customer.

24. The program of claim 22, wherein the calculating step further comprises the steps of:
accessing a weight for each of the selected types of data related to the customer; and
calculating the prediction index for the customer based on the score for each of the selected types of data related to the customer and the weight for each of the selected types of data related to the customer.

25. The program of claim 24, wherein the data processing system is controlled to calculate the weight for each of the selected types of data related to the customer by regression.

26. The program of claim 22, wherein the step of determining the score for each of the selected types of data related to the customer comprising the steps of:
accessing reference data including scores to be assigned to each of the selected types of data;
comparing each of the selected types of data with corresponding reference data; and
determining the score for each of the selected types of data based on a result of the comparing step.

27. The program of claim 22 further controls the data processing system to perform the steps of:
accessing data related to a profit threshold;
comparing the prediction index with the data related to the profit threshold;
indicating whether the customer is desirable based on a result of the comparing step.

28. A customer rating method comprising the steps of:
accessing data related to a customer, the accessed data including at least two types of data selected from the group consisting of: assets levels of the customer, demographic information of the customer, and transaction history of the customer; and
determining a prediction index for the customer based on the selected types of data related to the customer;
wherein the prediction index predicts a profit trend that the customer may generate.

29. The method of claim 28, wherein the prediction index is determined by steps comprising:
determining a score for each of the selected types of data related to the customer; and
calculating the prediction index for the customer based on the score for each of the selected types of data related to the customer.

30. The method of claim 29, wherein the step of calculating the prediction index for the customer comprises adding the score for each of the selected types of data related to the customer.

31. The method of claim 29, wherein the calculating step further comprises the steps of:
accessing a weight for each of the selected types of data related to the customer; and
calculating the prediction index for the customer based on the score for each of the selected types of data related to the customer and the weight for each of the selected types of data related to the customer.

32. The method of claim 31, wherein the weight for each of the selected types of data related to the customer is determined by regression.

33. The method of claim 29, wherein the step of determining the score for each of the selected types of data related to the customer comprises the steps of:
accessing reference data including scores to be assigned to each of the selected types of data;
comparing each of the selected types of data with corresponding reference data; and
determining the score for each of the selected types of data based on a result of the comparing step.

34. The method of claim 28 further comprising the steps of:
accessing data related to a profit threshold;
comparing the prediction index with the data related to the profit threshold; and
indicating whether the customer is desirable based on a result of the comparing step.

35. The method of claim 28, wherein the profit trend indicates a tendency of a client in generating profits.

36. The method of claim 35, wherein profits are associated with trading or brokerage profits.

37. The method of claim 28 further comprising a step of determining a level of service to the customer based on the calculated prediction index.

38. The method of claim 37, wherein the service level relates to the priority of answering a phone call made by the customer.
